(19) United States
(12) Patent Application Publication
(10) Pub. No.: US 2015/0240602 A1
(43) Pub. Date: Aug. 27, 2015

(54) Gas Well Deliquification by Liquid Entrainment

(71) Applicants: Andrey A. Troshko, Pearland, TX (US); Michael C. Romer, The Woodlands, TX (US)

(72) Inventors: Andrey A. Troshko, Pearland, TX (US); Michael C. Romer, The Woodlands, TX (US)

(21) Appl. No.: 14/617,072

(22) Filed: Feb. 9, 2015

Related U.S. Application Data
(60) Provisional application No. 61/943,949, filed on Feb. 24, 2014.

(51) Int. Cl. E21B 41/00; G01F 1/00; B05B 17/06; E21B 43/12

(52) U.S. Cl. CPC E21B 41/00; E21B 43/122; G01F 1/00; B05B 17/0607

(57) ABSTRACT

A method for removing liquids from a gas well. The method includes the steps of atomizing gas well liquids within a wellbore to produce a volume weighted average droplet size of less than or equal to about 400 μm; dispersing the atomized gas well liquids within a gaseous production stream; producing the gaseous production stream having dispersed atomized gas well liquids; and adjusting atomization parameters to maximize the rate of gas well liquids removed. A system, apparatus and kit of parts for removing liquids from a gas well are also provided.

### CROSS REFERENCE TO RELATED APPLICATIONS

This application claims the benefit of U.S. Provisional No. 61/943,949, filed Feb. 24, 2014, which is incorporated herein in its entirety for all purposes.

### FIELD

The present disclosure relates to an apparatus, method and kit of parts for removing fluids from a gas well.

### BACKGROUND

The majority of gas production wells eventually experience the appearance of liquids at some point in their production history. These liquids include water and/or hydrocarbons. Their origin can be the reservoir, water coning is one example, or it can be a change in well pressure and temperature leading to condensation and/or condensate dropout. Regardless of origin, the presence of liquids provides an additional hydraulic resistance to the driving pressure difference of the reservoir and the wellhead choke.

If accumulating liquids are not removed continuously, they can reduce gas production or even completely terminate production. Gas well deliquification can be split into active and passive methods. Active methods are all kinds of pumps which add energy to the liquid to move it to the surface. However pumps and associated piping are expensive to install and maintain which may not justify their use in low gas production wells. Passive methods rely on the available reservoir to choke pressure differential while modifying well geometry (velocity strings), liquids (foaming, gas-lifting), or production patterns (plungers) to enable deliquification. In general, passive methods are cheaper than active, but their capacity is limited and/or they have other restrictions.

Passive foaming methods have been employed recently to remove relatively low liquid volumes from a gas well. In these methods, foam is used to create a mixture of immiscible gas and liquid. The mixture of gas and liquid has an effective density that is less than the liquid alone, thus the critical gas velocity required to lift the foam is less than the critical velocity required for pure liquid. If the actual gas velocity in the well is above the foam critical velocity, foam lift occurs.

To employ foaming techniques, laboratory testing is necessary prior to foaming to ensure that the applied soap is suitable for a particular well. An effective soap should form stable foam that breaks up quickly downstream of the wellhead. Soap can be delivered either in liquid form through surface pumps or dedicated strings or it can be dropped down a well as soap sticks. In any case a constant supply of soap is needed. These issues tend to make foaming less desirable.

As such, there exists a need to address the aforementioned problems and issues. Therefore, what is needed is a passive deliquification apparatus and method that is free of the restrictions inherent with other passive methods.

### SUMMARY

In one aspect, disclosed herein is a method for removing liquids from a gas well. The method includes the steps of (a) atomizing gas well liquids within a wellbore to produce a volume weighted average droplet size of less than or equal to about 400 μm; (b) dispersing the atomized gas well liquids within a gaseous production stream; (c) producing the gaseous production stream having dispersed atomized gas well liquids; and (d) adjusting atomization parameters to maximize the rate of gas well liquids removed.

In some embodiments, the velocity of produced gas is determined prior to conducting steps (a)-(d).

In some embodiments, the average droplet size of step (a) is selected with reference to the velocity of produced gas.

In some embodiments, the gas well liquids comprise a mixture of hydrocarbons and water.

In some embodiments, the method of atomizing gas well liquids of step (a) includes at least one piezoelectric device, pneumatic atomizer, atomizing nozzle, surface acoustic wave transducer, and combinations thereof. Optionally, this group may also include a chemical reaction-based effervescent fluid atomizer to further assist with atomization if helpful.

In some embodiments, the method of atomizing gas well liquids within a wellbore includes a plurality of atomizing devices which may be arranged in a stack, in parallel, and/or in a series of sequential stages to increase the lift capacity and/or contact area for atomization, thus improving the maximum mist throughput of the device. The stack configuration could be optimized for the predicted liquid volumetric flow. The individual devices could be suspended separately along a powering cable to provide the best conditions for liquid and gas flow. Engineered tubes could carry produced liquids to the plurality of atomizing devices to ensure equal liquids distribution and maximize effectiveness. Gas could flow around and through the stack, transporting mist out of the well.

In some embodiments, the at least one piezoelectric device includes a piezoelectric atomizer, a piezoelectric nebulizer or a piezoelectric actuator.

In some embodiments, the at least one piezoelectric device includes a plurality of piezoelectric atomizers.

In some embodiments, each piezoelectric atomizer produces a volume weighted average droplet size of about 1 to about 90 μm. In some embodiments, each piezoelectric atomizer produces a volume weighted average droplet size of about 1 to about 50 μm. In some embodiments, each piezoelectric atomizer produces a volume weighted average droplet size of about 1 to about 10 μm.

In some embodiments, each piezoelectric atomizer atomizes liquids at a rate of about 0.5 to about 1.5 l/hr. In some embodiments, the piezoelectric device includes at least eight piezoelectric atomizers and atomizes liquids at a rate of about 4.0 to about 12.0 l/hr.

In some embodiments, the method further includes the step of maintaining the position of the piezoelectric device adjacent the liquid/gas interface of the gas well.

In some embodiments, the piezoelectric device further comprises a circular base, the plurality of piezoelectric atomizers positioned about a radius thereof.

In some embodiments, the step of maintaining the position of the piezoelectric device adjacent the liquid/gas interface of the gas well includes the use of a float.

In some embodiments, the piezoelectric device is enclosed within a housing, the housing having a first end and a second end, the first end having a liquid inlet and structured and arranged to receive the piezoelectric device, and the second end having an outlet for dispersing the atomized gas well liquids within a gaseous production stream.

In another aspect, disclosed herein is a system for removing liquids from a gas well. The system includes an apparatus for atomizing gas well liquids within a wellbore to produce a volume weighted average droplet size of less than or equal to about 400 μm and entraining the atomized gas well liquids in a gaseous production stream for removal from the gas well; and an atomization controller for adjusting atomization parameters to maximize the rate of gas well liquids removed.

In some embodiments, the system further includes a flow meter for determining the velocity of produced gas.

In some embodiments, the average droplet size is selected with reference to the velocity of produced gas.

In some embodiments, the apparatus for atomizing gas well liquids within a wellbore comprises at least one piezoelectric device, pneumatic atomizer, atomizing nozzle, surface acoustic wave transducer, and combinations thereof. Optionally, this group may also include a chemical reaction-based effervescent fluid atomizer to further assist with atomization if helpful.

In some embodiments, the apparatus for atomizing gas well liquids within a wellbore comprises a plurality of atomizing devices which may be arranged in a stack, in parallel, or series to increase the contact area for atomization, thus improving the maximum mist throughput of the device. The stack configuration could be optimized for the predicted liquid volumetric flow. The individual devices could be suspended separately along a powering cable to provide the best conditions for liquid and gas flow. Engineered tubes could carry produced liquids to the plurality of atomizing devices to ensure equal liquids distribution and maximize effectiveness. Gas could flow around and through the stack, transporting mist out of the well.

In some embodiments, the at least one piezoelectric device includes at least one piezoelectric atomizer, piezoelectric nebulizer or piezoelectric actuator.

In some embodiments, the piezoelectric device includes a plurality of piezoelectric atomizers.

In some embodiments, the apparatus for atomizing gas well liquids within a wellbore further includes a circular base, the plurality of piezoelectric atomizers positioned about a radius thereof.

In some embodiments, each piezoelectric atomizer produces a volume weighted average droplet size of about 1 to about 90 μm. In some embodiments, each piezoelectric atomizer produces a volume weighted average droplet size of about 1 to about 50 μm. In some embodiments, each piezoelectric atomizer produces a volume weighted average droplet size of about 1 to about 10 μm.

In some embodiments, each piezoelectric atomizer atomizes liquids at a rate of about 0.5 to about 1.5 l/hr. In some embodiments, the piezoelectric device includes at least eight piezoelectric atomizers and atomizes liquids at a rate of about 4.0 to about 12.0 l/hr.

In some embodiments, the apparatus for atomizing gas well liquids within a wellbore further comprises a float for maintaining the position of the plurality of piezoelectric atomizers adjacent the liquid/gas interface of the gas well.

In some embodiments, the apparatus for atomizing gas well liquids within a wellbore further comprises a housing, the housing having a first end and a second end, the first end having a liquid inlet and structured and arranged to receive the piezoelectric device, and the second end having an outlet for dispersing the atomized gas well liquids within a gaseous production stream.

In some embodiments, the apparatus for atomizing gas well liquids within a wellbore is deployed, powered, and retrieved with wire line.

In some embodiments, the gas well liquids comprise a mixture of hydrocarbons and water.

In another aspect, disclosed herein is a kit of parts for removing liquids from a gas well. The kit of parts includes an apparatus for atomizing gas well liquids within a wellbore to produce a volume weighted average droplet size of less than or equal to about 400 μm and entraining the atomized gas well liquids in a gaseous production stream for removal from the gas well; and an atomization controller for adjusting atomization parameters to maximize the rate of gas well liquids removed.

In some embodiments, the kit of parts further includes a flow meter for determining the velocity of produced gas.

In some embodiments, the average droplet size is selected with reference to the velocity of produced gas.

In some embodiments, the apparatus for atomizing gas well liquids within a wellbore comprises at least one piezoelectric device, pneumatic atomizer, atomizing nozzle, surface acoustic wave transducer, and combinations thereof. Optionally, this group may also include a chemical reaction-based effervescent fluid atomizer to further assist with atomization if helpful.

In some embodiments, the apparatus for atomizing gas well liquids within a wellbore comprises a plurality of atomizing devices which may be arranged in a stack to increase the contact area for atomization, thus improving the maximum mist throughput of the device. The stack configuration could be optimized for the predicted liquid volumetric flow. The individual devices could be suspended separately along a powering cable to provide the best conditions for liquid and gas flow. Engineered tubes could carry produced liquids to the plurality of atomizing devices to ensure equal liquids distribution and maximize effectiveness. Gas could flow around and through the stack, transporting mist out of the well.

In some embodiments, the at least one piezoelectric device includes at least one piezoelectric atomizer, piezoelectric nebulizer or piezoelectric actuator.

In some embodiments, the piezoelectric device includes a plurality of piezoelectric atomizers.

In some embodiments, the apparatus for atomizing gas well liquids within a wellbore further includes a circular base, the plurality of piezoelectric atomizers positioned about a radius thereof.

In some embodiments, each piezoelectric atomizer produces a volume weighted average droplet size of about 1 to about 90 μm. In some embodiments, each piezoelectric atomizer produces a volume weighted average droplet size of about 1 to about 50 μm. In some embodiments, each piezoelectric atomizer produces a volume weighted average droplet size of about 1 to about 10 μm.

In some embodiments, each piezoelectric atomizer atomizes liquids at a rate of about 0.5 to about 1.5 l/hr. In some embodiments, the piezoelectric device includes at least eight piezoelectric atomizers and atomizes liquids at a rate of about 4.0 to about 12.0 l/hr.

In some embodiments, the apparatus for atomizing gas well liquids within a wellbore further includes a housing, the housing has a first end and a second end, the first end having a liquid inlet and structured and arranged to receive the piezoelectric device, and the second end having an outlet for dispersing the atomized gas well liquids within a gaseous production stream.

In some embodiments, the apparatus for atomizing gas well liquids within a wellbore further comprises a float for maintaining the position of the plurality of piezoelectric atomizers adjacent the liquid/gas interface of the gas well, the float affixed to an outer surface of the housing.

In some embodiments, the kit of parts further includes a wire line for deploying, powering, and retrieving the piezoelectric device.

In some embodiments, the kit of parts is structured and arranged to function in both vertical and horizontal wells.

In yet another aspect, disclosed herein is an apparatus for removing liquids from a gas well. The apparatus includes a piezoelectric device for atomizing gas well liquids and entraining the atomized liquids in a gaseous production stream for removal from the gas well; and an apparatus for maintaining the position of the piezoelectric device adjacent the liquid/gas interface of the gas well.

In still yet another aspect, disclosed herein is a method for removing liquids from a gas well, the method comprising the steps of (a) positioning a piezoelectric device for atomizing gas well liquids adjacent the liquid/gas interface of the gas well; (b) powering the piezoelectric device and generating droplets; (c) entraining the droplets in a gaseous production stream; (d) producing the gaseous production stream having entrained droplets; and (e) maintaining the position of the piezoelectric device adjacent the liquid/gas interface of the gas well.

In a further aspect, disclosed herein is an kit of parts for removing liquids from a gas well, the kit of parts comprising a piezoelectric device for atomizing gas well liquids and entraining the atomized liquids in a gaseous production stream for removal from the gas well; and an apparatus for maintaining the position of the piezoelectric device adjacent the liquid/gas interface of the gas well, wherein the piezoelectric device is enclosed within a housing, the housing has a first end and a second end, the first end having a liquid inlet and structured and arranged to receive the piezoelectric device, and the second end having an outlet for dispersing the atomized gas well liquids within a gaseous production stream.

### BRIEF DESCRIPTION OF THE DRAWINGS

FIG. 1 presents a schematic view of an illustrative, nonexclusive example of a system for removing liquids from a gas well, according to the present disclosure.

FIG. 2 presents a top plan view of an illustrative, non-exclusive example of a base having a plurality of piezoelectric atomizers positioned about a radius thereof for use in an apparatus for atomizing gas well liquids within a wellbore, according to the present disclosure.

FIG. 3 presents a side view of an illustrative, non-exclusive example of a housing for enclosing an apparatus for atomizing gas well liquids within a wellbore, according to the present disclosure.

FIG. 4, presents a process flowchart of an illustrative, non-exclusive example of a method for removing liquids from a gas well, in accordance herewith.

FIG. 5 presents a schematic view of an illustrative, non-exclusive example of a system for removing liquids from a gas well, according to the present disclosure, installed in a vertical gas well having an issue with excess gas well liquids.

FIG. 6 presents a schematic view of an illustrative, non-exclusive example of a system for removing liquids from a gas well, according to the present disclosure, installed in the vertical gas well of FIG. 5, wherein the excess gas well liquids have been removed.

FIG. 7 presents a schematic view of an illustrative, non-exclusive example of a system for removing liquids from a gas well, according to the present disclosure, installed in a horizontal gas well having an issue with excess gas well liquids.

FIG. 8 presents a schematic view of an illustrative, non-exclusive example of a system for removing liquids from a gas well, according to the present disclosure, installed in the horizontal gas well of FIG. 7, wherein the excess gas well liquids have been removed.

### DETAILED DESCRIPTION

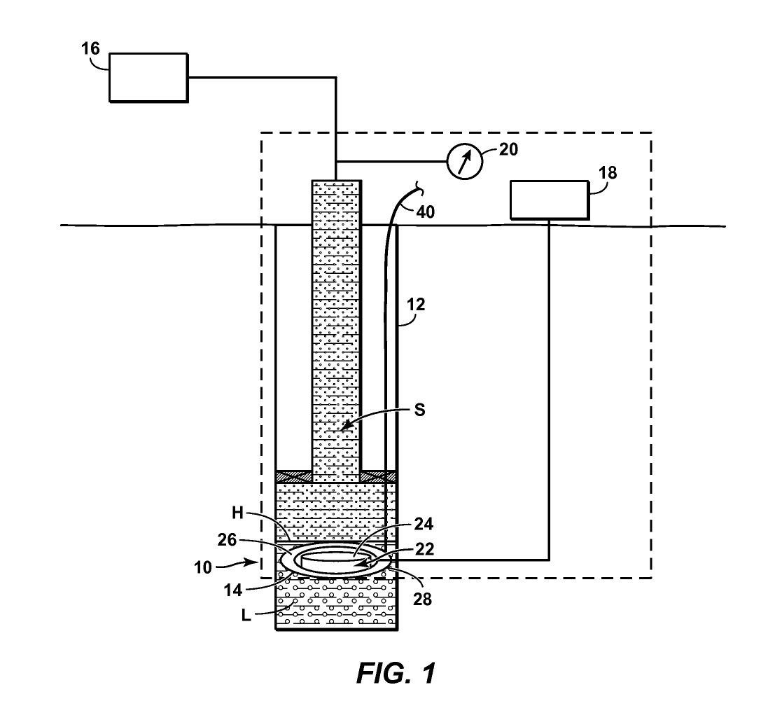

FIGS. 1-8 provide illustrative, non-exclusive examples of a method, system and kit of parts for removing liquids from a gas well, according to the present disclosure, together with elements that may include, be associated with, be operatively attached to, and/or utilize such a method, system or kit of parts for removing liquids from a gas well.

In FIGS. 1-8, like numerals denote like, or similar, structures and/or features; and each of the illustrated structures and/or features may not be discussed in detail herein with reference to the figures. Similarly, each structure and/or feature may not be explicitly labeled in the figures; and any structure and/or feature that is discussed herein with reference to the figures may be utilized with any other structure and/or feature without departing from the scope of the present disclosure.

In general, structures and/or features that are, or are likely to be, included in a given embodiment are indicated in solid lines in the figures, while optional structures and/or features are indicated in broken lines. However, a given embodiment is not required to include all structures and/or features that are illustrated in solid lines therein, and any suitable number of such structures and/or features may be omitted from a given embodiment without departing from the scope of the present disclosure.

Referring now to FIG. 1, a schematic view of an illustrative, nonexclusive example of a system 10 for removing liquids from a gas well 12, according to the present disclosure, is shown. As may be appreciated, the gas well liquids may comprise a mixture of hydrocarbons and water. In some cases, the gas well liquids may predominately comprise water.

The system 10 includes an apparatus for atomizing gas well liquids within a wellbore 14. Advantageously, the apparatus for atomizing gas well liquids within a wellbore 14 is structured and arranged to produce a volume weighted average droplet size of less than or equal to about 400 μm. Upon atomizing the gas well liquids L, the atomized gas well liquids are entrained in a gaseous production stream to form an atomized liquid/gaseous stream S for removal from the gas well 12. The atomized liquid/gaseous stream S may be sent to an optional dryer 16 to separate and remove the atomized liquids from the gaseous stream.

System 10 includes an atomization controller 18, which may be located above ground, as shown or downhole and included as part of the apparatus for atomizing gas well liquids within a wellbore 14. As will be described in more detail hereinbelow, atomization controller 18 is designed to permit the atomization parameters to be adjusted in order to maximize the rate of gas well liquids removed.

In some embodiments, the system further includes a flow meter 20 for determining the velocity of produced gas. As will be described further, in some embodiments, the average droplet size is selected with reference to the velocity of produced gas.

To atomize gas well liquids within a wellbore the apparatus 14 may include at least one piezoelectric device 22. In other aspects, the apparatus 14 may include at least one and or a plurality of redundant components, such as the pneumatic atomizer, atomizing nozzle, surface acoustic wave transducer, chemical reaction-based effervescent fluid atomizer, or combinations thereof (not shown). In some embodiments, the apparatus 14 may include a plurality of said atomizing devices that may be arranged in a common stack (e.g., a grouping, such as in parallel, and/or in series, or spaced out along the liquid-collecting portion of the wellbore, such as to provide lift rate and/or pressure stages of increasing atomization of the liquid collected within the wellbore, as or as otherwise desired, in order to maximize liquid throughput and effectiveness (not shown) from within each atomizer and along the wellbore length. In some embodiments, the at least one piezoelectric device 22 includes at least one piezoelectric atomizer 24, piezoelectric nebulizer or piezoelectric actuator.

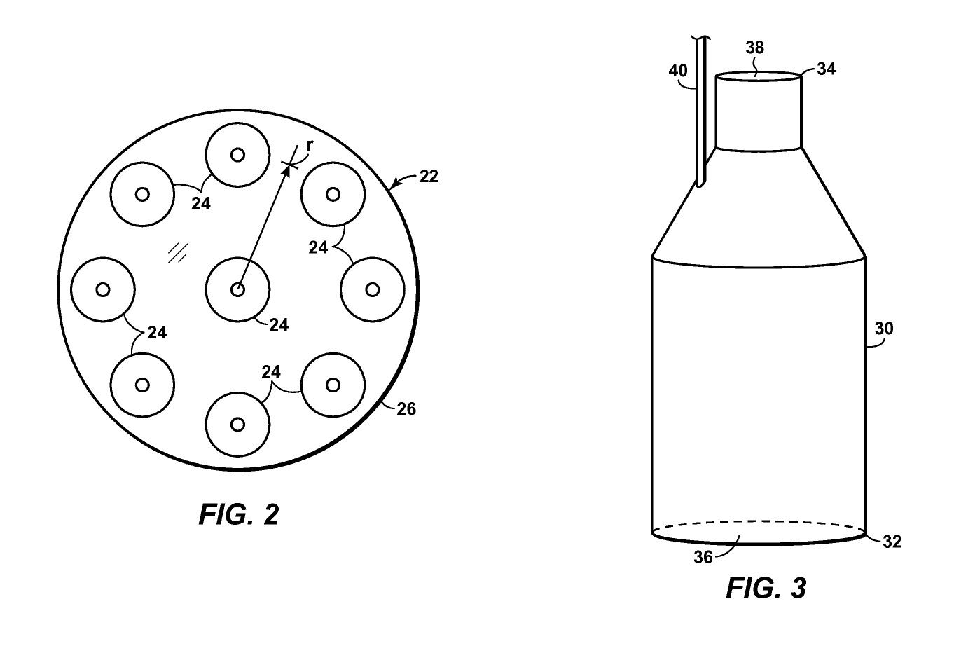

Referring now to FIG. 2, in some embodiments, the piezoelectric device 22 includes a plurality of piezoelectric atomizers 24. As shown, the apparatus for atomizing gas well liquids within a wellbore 14 may further includes a substantially circular base 26, the plurality of piezoelectric atomizers 24 positioned about a radius r thereof.

Suitable piezoelectric atomizers are available from a variety of sources, including Johnson Matthey Catalysts GmbH, Piezoproducts, Bahnhofstrasse 43, D-96257 Redwitz, Germany. In some embodiments, each piezoelectric atomizer produces a volume weighted average droplet size of about 1 to about 90 μm. In some embodiments, each piezoelectric atomizer produces a volume weighted average droplet size of about 1 to about 50 μm. In some embodiments, each piezoelectric atomizer produces a volume weighted average droplet size of about 1 to about 10 μm. In some embodiments, each piezoelectric atomizer atomizes liquids at a rate of about 0.5 to about 1.5 l/hr. Still referring to FIG. 2, in some embodiments, the piezoelectric device includes at least eight piezoelectric atomizers (or nine, as shown) and atomizes liquids at a rate of about 4.0 to about 12.0 l/hr. or more.

In some embodiments, the apparatus for atomizing gas well liquids within a wellbore 14 further comprises a float 28 for maintaining the position of the plurality of piezoelectric atomizers 24 adjacent the liquid/gas interface I of the gas well 12.

Referring now to FIG. 3, the apparatus for atomizing gas well liquids within a wellbore 14 may also include a housing 30 for enclosing the apparatus 14. As shown, the housing 30 has a first end 32 and a second end 34. The first end 32 may be provided with at least one liquid inlet 36. The first end 32 is structured and arranged to receive the piezoelectric device 22. The second end 34 may be provided with an outlet 38 for dispersing the atomized gas well liquids within the gaseous production stream. In some embodiments, the apparatus for atomizing gas well liquids within a wellbore 14 is deployed, powered, and retrieved with a wire line 40.

As may be appreciated by those skilled in the art, gas phase hydrocarbons produced from underground reservoirs may have liquid phase constituents associated therewith. The presence of such liquid phase constituents can affect the flow characteristics of the well. Liquids can come from condensation of hydrocarbon gas or from water in the reservoir matrix. This discontinuous, higher density liquid phase must be transported to the surface by the gas or separately pumped to the surface, in the event the gas phase does not provide sufficient transport energy to lift the liquids out of the well.

Significantly, the accumulation of the liquid will place additional back pressure on the formation, which can severely affect the production capacity of the well. In low pressure wells, the liquid may completely kill the well. Other symptoms that may indicate liquid loading include: the well is showing an increasing difference between casing and tubing pressure as it loads; slugging may occur at the well head, upstream of any liquid knock-out device or separator; or a wireline pressure survey or sonic fluid level shot down the tubing while the well is producing gas shows the existence of a gassy liquid level in the tubing. A clear indication of liquid loading occurs when a well is still flowing, but at a lower, more erratic rate than normal.

As mentioned, in higher pressure wells, a variable degree of slugging of the liquids can occur, which can affect calculations used in routine well tests. Specifically, the calculated bottom-hole pressures used in backpressure tests will be off if the well is not removing liquids on a continuous basis, and gas-to-liquid ratios observed during such a test may not be correct.

Turner (R. G. Turner, M. G. Hubbard, and A. E. Dulder, Analysis and Prediction of Minimum Flow Rate for the Continuous Removal of Liquids from Gas Wells, SPE Paper 2198, SPE 43rd fall meeting, Houston, Tex., USA, 1968), and later Coleman (S. B. Coleman, H. B. Clay, D. G. McCurdy, H. Norris, “New Look At Predicting Gas Well Load Up,” JPT, Journal of Petroleum Technology, v.43 n.3, March 1991, p. 329 333) characterized loading as occurring when droplets of liquid in the tubing either rise or fall against the flow. They balanced the weight of liquid droplets vs. the upward drag force from the flow of gas. The gas production velocity and corresponding rate to just support the droplets and keep them from falling and accumulating in the bottom of the well is referred to as the critical or terminal velocity.

Turner noted that the terminal velocity is a function of the size, shape and density of the particle and of the density and viscosity of the fluid medium. Turner's general free settling velocity equation shows dependence on the densities of the phases and on the mass and projected area of the particle. Since the surface tension of the liquid phase acts to draw the drop into a spheroidal shape, Turner's general free settling velocity equation may be expressed as follows:

$$Vt = 6.55 \sqrt{\frac{d ( ρ l - ρ g )}{ρ gCd}} \qquad ( 1 )$$

wherein:
d=Droplet diameter in units of ft;
C_{d}=Coefficient of drag;
Vₜ=Terminal gas velocity in units of

$$\frac{ft}{s} ;$$

ρₗ=Liquid phase density in units of

$$\frac{lbm}{{ft}^{3}} ;$$

and
ρ_{g}=Gas phase density in units of

$$\frac{lbm}{{ft}^{3}} .$$

As such, Equation 1 demonstrates that the larger the drop, the higher the terminal velocity, all other things equal. Conversely, the smaller the drop, the lower the gas flow rate necessary to remove it from the gas well. The system and methods disclosed herein seek to create a mixture of liquid and gas at the bottom of the well, by converting the liquid into a fine mist consisting of small droplets. Droplets produced in accordance herewith may be in the range of about 1 to about less than 400 microns. Droplets of such size have very small mass and inertia and can be easily entrained into a flowing gas and lifted to the surface.

As those skilled in the art will recognize, a typical gas well produces brine, i.e., water with a very high concentration of salt, exceeding sea water salinity by several times. Laboratory tests with salt water (a salinity about twice that of typical sea water) have shown that salinity of produced water is the same as salinity of downhole water. Thus, mist creation advantageously leads to salt being removed from the well. Of course, were this not the case, wells would be clogged by the salt not removed.

The density of the gas and entrained mist mixture should be close to saturated gas density because the liquid mist volume rate is a very small fraction of the gas volume rate. As gas flows closer to the surface the liquid mist volume fraction will get even smaller due to gas expansion. The liquid droplet inertia is very small, so the droplets will follow the gas flow closely. Thus, impingement of liquid droplets on the well walls is minimal due to the small size of the droplets.

Fine liquid mist can be created in a variety of ways. As indicated above, one method disclosed herein is to use the piezoelectric effect, using devices such as piezoelectric actuators, atomizers, or nebulizers. In these devices, an electrical voltage is applied to a piezoelectric crystal located adjacent the liquid surface. The crystal oscillates at a frequency of a few kHz to several MHz, creating pressure waves. The pressure waves interact with the liquid surface to create tiny droplets. The frequency of piezoelectric crystal oscillation can be regulated to create droplets of different sizes. The atomization controller disclosed herein is designed to permit atomization parameters, such as frequency, to be adjusted in order to maximize the rate of gas well liquids removed.

As indicated above, the systems and methods disclosed herein may employ one or more pneumatic atomizers, atomizing nozzles, surface acoustic wave transducers, chemical reaction-based effervescent fluid atomizers, and/or combinations thereof. Surface acoustic wave transducers are described more detail in M. Kurosawa, A. Futami, and T. Higuchi, “Characteristics of Liquids Atomization Using Surface Acoustic Wave,” Dept. of Precision Machinery Engineering, The University of Tokyo, Hongo, Bunkyo-ku, Tokyo 113, Japan. An effervescent liquid fine mist apparatus and method is described in U.S. Pat. No. 6,598,802, the contents of which are incorporated by reference for all that they disclose.

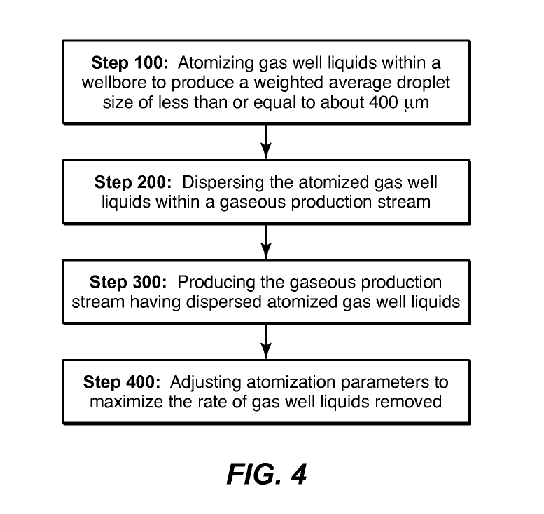

Referring now to FIG. 4, a flowchart of an illustrative, non-exclusive example of a method for removing liquids from a gas well, according to the present disclosure, is presented. As shown, in Step 100, gas well liquids within a wellbore are atomized to produce a volume weighted average droplet size of less than or equal to about 400 μm. In Step 200, the atomized gas well liquids are dispersed within a gaseous production stream. In Step 300, the gaseous production stream having dispersed atomized gas well liquids is produced. In Step 400, atomization parameters are adjusted to maximize the rate of gas well liquids removed. In some embodiments, the velocity of produced gas is determined prior to conducting Steps 100-400. In some embodiments, the average droplet size of Step 100 may be selected with reference to the velocity of produced gas.

As indicated, in some embodiments, the method of atomizing gas well liquids of Step 100 includes at least one piezoelectric device, pneumatic atomizer, atomizing nozzle, surface acoustic wave transducer, and combinations thereof. Optionally, this group may also include a chemical reaction-based effervescent fluid atomizer to further assist with atomization if helpful.

In some embodiments, the method of atomizing gas well liquids within a wellbore includes utilizing a plurality of atomizing devices which may be arranged as desired such as in a stack (grouping, such as in parallel or series) to increase the contact area for atomization, thus improving the maximum mist throughput of the device. The stack configuration could be optimized for the predicted liquid volumetric flow. The individual devices could be suspended separately along a powering cable to provide the best conditions for liquid and gas flow. Engineered tubes could carry produced liquids to the plurality of atomizing devices to ensure equal liquids distribution and maximize effectiveness. Gas could flow around and through the stack, transporting mist out of the well.

In some embodiments, the at least one piezoelectric device includes a piezoelectric atomizer, a piezoelectric nebulizer or a piezoelectric actuator. In some embodiments, the at least one piezoelectric device includes a plurality of piezoelectric atomizers.

In some embodiments, each piezoelectric atomizer produces a volume weighted average droplet size of about 1 to about 90 μm. In some embodiments, each piezoelectric atomizer produces a volume weighted average droplet size of about 1 to about 50 μm. In some embodiments, each piezoelectric atomizer produces a volume weighted average droplet size of about 1 to about 10 μm.

In some embodiments, each piezoelectric atomizer atomizes liquids at a rate of about 0.5 to about 1.5 l/hr. In some embodiments, the piezoelectric device includes at least eight piezoelectric atomizers and atomizes liquids at a rate of about 4.0 to about 12.0 l/hr.

In some embodiments, the method further includes the step of maintaining the position of the piezoelectric device adjacent the liquid/gas interface of the gas well. In some embodiments, the step of maintaining the position of the piezoelectric device adjacent the liquid/gas interface of the gas well includes the use of a float.

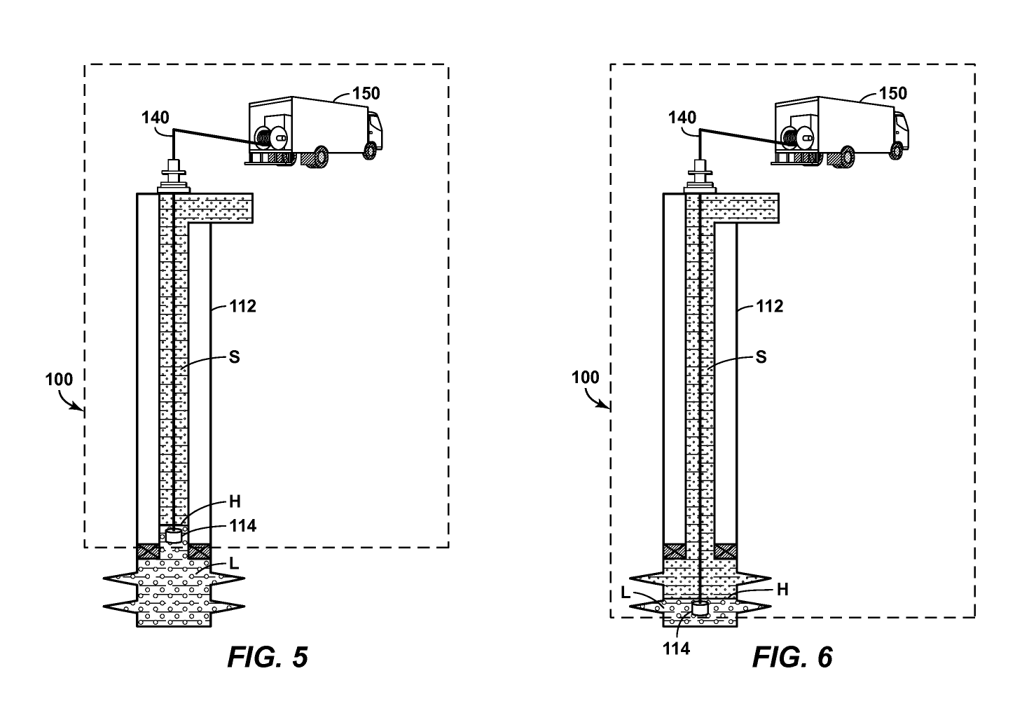

Referring now to FIG. 5, a schematic view of an illustrative, non-exclusive example of a system for removing liquids from a gas well 100, in accordance herewith, is presented. As shown, system 100 is installed in a vertical gas well having an issue with excess gas well liquids. The system 100 includes an apparatus for atomizing gas well liquids within a wellbore 114. As with the previously described embodiments, the apparatus for atomizing gas well liquids 114 within a gas well 112 is structured and arranged to produce a volume weighted average droplet size of less than or equal to about 400 μm. Upon atomizing the gas well liquids L, the atomized gas well liquids are entrained in a gaseous production stream to form an atomized liquid/gaseous stream S for removal from the gas well 112. The atomized liquid/gaseous stream S may be sent to an optional dryer (not shown) to separate and remove the atomized liquids from the gaseous stream.

System 100 includes an atomization controller (not shown), which may be located above ground, in service truck 150, or downhole and included as part of the apparatus for atomizing gas well liquids within a wellbore 114. The atomization controller is designed to permit the atomization parameters to be adjusted in order to maximize the rate of gas well liquids removed from gas well 112. System 100 may also include a flow meter (not shown) for determining the velocity of produced gas. As described above, the average droplet size may be selected with reference to the velocity of produced gas.

To atomize gas well liquids within the wellbore, apparatus 114 may include at least one piezoelectric device (not shown). Alternatively, the apparatus 114 may include at least one, pneumatic atomizer, atomizing nozzle, surface acoustic wave transducer, chemical reaction-based effervescent fluid atomizer, or combinations thereof (not shown). In some embodiments, the apparatus 114 may include a plurality of said atomizing devices that may be arranged in a stack to maximize liquid throughput and effectiveness (not shown). In some embodiments, the at least one piezoelectric device includes at least one piezoelectric atomizer, piezoelectric nebulizer or piezoelectric actuator (not shown).

Once system 100 is installed, the gas well liquids are atomized to produce a volume weighted average droplet size of less than or equal to about 400 μm and the atomized gas well liquids are dispersed within a gaseous production stream. Then, the gaseous production stream is produced. The atomization parameters are adjusted to maximize the rate of gas well liquids removed. Again, the velocity of produced gas may be determined and the average droplet size selected with reference to the velocity of produced gas.

This process continues until the liquids level is reduced to an acceptable level. In FIG. 6, a schematic view of system 100 is depicted, wherein the excess gas well liquids have been removed.

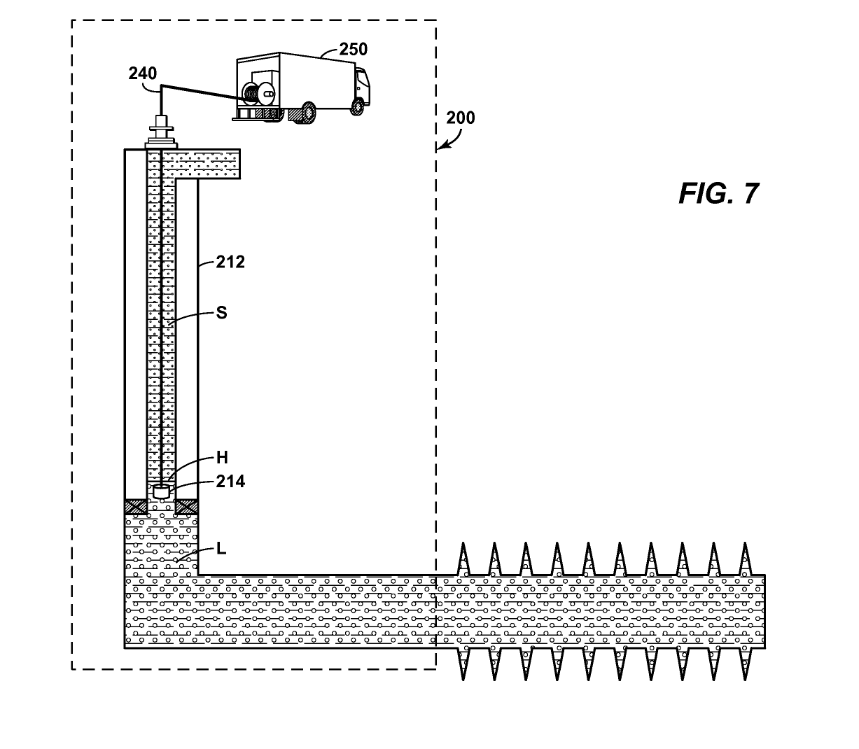

Referring now to FIG. 7 presents a schematic view of an illustrative, non-exclusive example of a system for removing liquids from a gas well 200, in accordance herewith, is presented. As shown, system 200 is installed in a horizontal gas well having an issue with excess gas well liquids. The system 200 includes an apparatus for atomizing gas well liquids within a wellbore 214. As with the previously described embodiments, the apparatus for atomizing gas well liquids 214 within a gas well 212 is structured and arranged to produce a volume weighted average droplet size of less than or equal to about 400 μm. Upon atomizing the gas well liquids L, the atomized gas well liquids are entrained in a gaseous production stream to form an atomized liquid/gaseous stream S for removal from the gas well 212. The atomized liquid/gaseous stream S may be sent to an optional dryer (not shown) to separate and remove the atomized liquids from the gaseous stream.

System 200 includes an atomization controller (not shown), which may be located above ground, in service truck 250, or downhole and included as part of the apparatus for atomizing gas well liquids within a wellbore 214. The atomization controller is designed to permit the atomization parameters to be adjusted in order to maximize the rate of gas well liquids removed from gas well 212. System 200 may also include a flow meter (not shown) for determining the velocity of produced gas. As described above, the average droplet size may be selected with reference to the velocity of produced gas.

To atomize gas well liquids within the wellbore, apparatus 214 may include at least one piezoelectric device (not shown). Alternatively, the apparatus 214 may include at least one, pneumatic atomizer, atomizing nozzle, surface acoustic wave transducer, chemical reaction-based effervescent fluid atomizer, or combinations thereof (not shown). In some embodiments, the apparatus 214 may include a plurality of said atomizing devices that may be arranged in a stack to maximize liquid throughput and effectiveness (not shown). In some embodiments, the at least one piezoelectric device includes at least one piezoelectric atomizer, piezoelectric nebulizer or piezoelectric actuator (not shown).

Once system 200 is installed, the gas well liquids are atomized to produce a volume weighted average droplet size of less than or equal to about 400 μm and the atomized gas well liquids are dispersed within a gaseous production stream. Then, the gaseous production stream is produced. The atomization parameters are adjusted to maximize the rate of gas well liquids removed. Again, the velocity of produced gas may be determined and the average droplet size selected with reference to the velocity of produced gas.

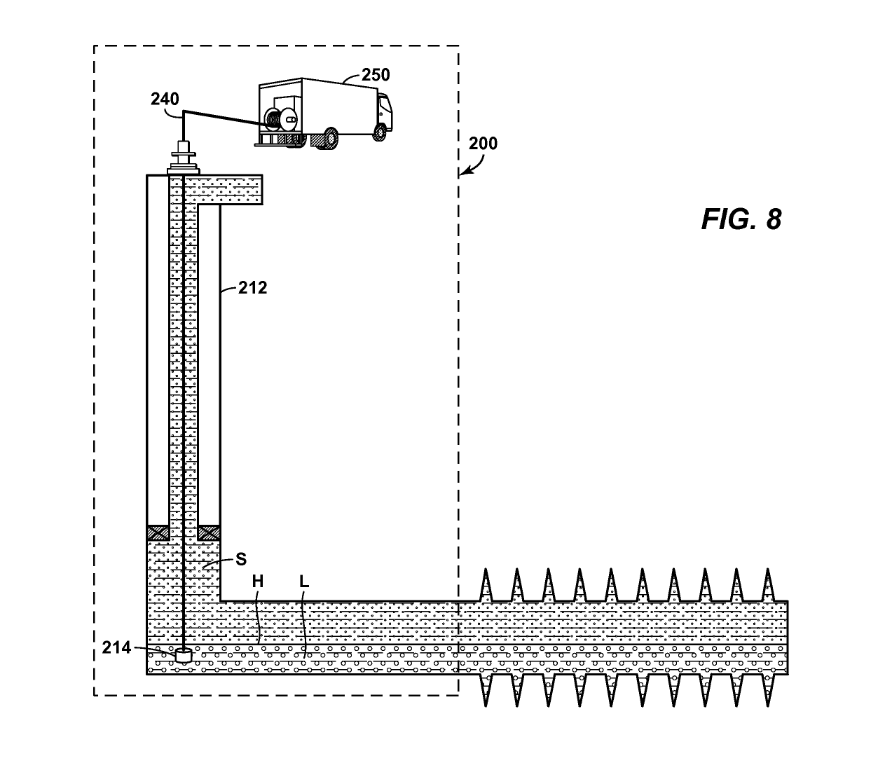

This process continues until the liquids level is reduced to an acceptable level. In FIG. 8, a schematic view of system 200 is depicted, wherein the excess gas well liquids have been removed from the horizontal gas well 212 of FIG. 7.

In another aspect, disclosed herein is a kit of parts for removing liquids from a gas well. The kit of parts includes an apparatus for atomizing gas well liquids within a wellbore to produce a volume weighted average droplet size of less than or equal to about 400 μm and entraining the atomized gas well liquids in a gaseous production stream for removal from the gas well; and an atomization controller for adjusting atomization parameters to maximize the rate of gas well liquids removed. In some embodiments, the kit of parts further includes a flow meter for determining the velocity of produced gas. In some embodiments, the average droplet size is selected with reference to the velocity of produced gas.

In some embodiments, the apparatus for atomizing gas well liquids within a wellbore comprises at least one piezoelectric device, pneumatic atomizer, atomizing nozzle, surface acoustic wave transducer, and combinations thereof. Optionally, this group may also include a chemical reaction-based effervescent fluid atomizer to further assist with atomization if helpful.

In some embodiments, the apparatus for atomizing gas well liquids within a wellbore comprises a plurality of atomizing devices which may be arranged in a stack to increase the contact area for atomization, thus improving the maximum mist throughput of the device. The stack configuration could be optimized for the predicted liquid volumetric flow. The individual devices could be suspended separately along a powering cable to provide the best conditions for liquid and gas flow. Engineered tubes could carry produced liquids to the plurality of atomizing devices to ensure equal liquids distribution and maximize effectiveness. Gas could flow around and through the stack, transporting mist out of the well.

In some embodiments, the at least one piezoelectric device includes at least one piezoelectric atomizer, piezoelectric nebulizer or piezoelectric actuator.

In some embodiments, the piezoelectric device includes a plurality of piezoelectric atomizers.

### Example

A test of the systems and methods disclosed were conducted using a laboratory rig similar to that depicted generally in FIG. 1. Constant pressure air was supplied to the bottom of a half water-filled bubbler. Air bubbles rose through the water, became saturated, and were injected through the bottom of a partially water-filled pipe. The pipe simulated a well, the water in the pipe simulated accumulated gas well liquids, and the bubbling air simulated gas production.

A piezoelectric atomizer was attached to a float so that the piezoelectric crystal was positioned close to the liquid-air interface. When voltage was applied to the atomizer, a mist formed just above the water surface and was picked up by air formed from surfacing bubbles. The mist was then lifted by the upcoming air.

The tests conducted demonstrated the stable effectiveness of the systems and methods disclosed herein, as the initial liquid level in the simulated well was lowered by mist entrainment operations. The liquid on the pipe walls was negligible in comparison to the lifted liquid volume.

All or a portion of the methods, systems and subsystems of the exemplary embodiments can be conveniently implemented using one or more general purpose computer systems, microprocessors, digital signal processors, microcontrollers, and the like, programmed according to the teachings of the exemplary embodiments disclosed herein, as will be appreciated by those skilled in the computer and software arts.

Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments disclosed herein can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of a form disclosed herein for performing all or a portion (if processing is distributed) of the processing performed in implementing the methods disclosed herein. Computer code devices of the exemplary embodiments disclosed herein can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments disclosed herein can be distributed for better performance, reliability, cost, and the like.

As stated above, the methods, systems, and subsystems of the exemplary embodiments can include computer readable medium or memories for holding instructions programmed according to the embodiments disclosed herein and for holding data structures, tables, records, and/or other data described herein. Computer readable medium can include any suitable medium that participates in providing instructions to a processor for execution. Such a medium can take many embodiments, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common embodiments of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The embodiments disclosed herein, as illustratively described and exemplified hereinabove, have several beneficial and advantageous aspects, characteristics, and features. The embodiments disclosed herein successfully address and overcome shortcomings and limitations, and widen the scope, of currently known teachings with respect to removing liquids from a gas wells.

As used herein, the term “and/or” placed between a first entity and a second entity Means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

### INDUSTRIAL APPLICABILITY

The apparatus and methods disclosed herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method for removing liquids from a gas well, the method comprising the steps of:
(a) atomizing gas well liquids within a wellbore to produce a volume weighted average droplet size of less than or equal to about 400 μm;
(b) dispersing the atomized gas well liquids within a gaseous production stream;
(c) producing the gaseous production stream having dispersed atomized gas well liquids; and
(d) adjusting atomization parameters to maximize the rate of gas well liquids removed.

2. The method of claim 1, further comprising the step of determining the velocity of produced gas, prior to conducting steps (a)-(d).

3. The method of claim 2, wherein the average droplet size of step (a) is selected with reference to the velocity of produced gas.

4. The method of claim 3, wherein the gas well liquids comprise a mixture of hydrocarbons and water.

5. The method of claim 3, wherein the method of atomizing gas well liquids of step (a) includes at least one piezoelectric device, pneumatic atomizer, atomizing nozzle, surface acoustic wave transducer, and combinations thereof.

6. The method of claim 5, wherein the at least one piezoelectric device includes a piezoelectric atomizer, a piezoelectric nebulizer or a piezoelectric actuator.

7. The method of claim 6, wherein the at least one piezoelectric device includes a plurality of piezoelectric atomizers.

8. The method of claim 7, wherein each piezoelectric atomizer produces a volume weighted average droplet size of about 1 to about 90 μm.

9. The method of claim 8, wherein each piezoelectric atomizer atomizes liquids at a rate of about 0.5 to about 1.5 l/hr.

10. The method of claim 9, wherein the piezoelectric device includes at least eight piezoelectric atomizers and atomizes liquids at a rate of about 4.0 to about 12.0 l/hr.

11. The method of claim 10, further comprising the step of maintaining the position of the piezoelectric device adjacent the liquid/gas interface of the gas well.

12. A system for removing liquids from a gas well, the system comprising:
(a) an apparatus for atomizing gas well liquids within a wellbore to produce a volume weighted average droplet size of less than or equal to about 400 μm and entraining the atomized gas well liquids in a gaseous production stream for removal from the gas well; and
(b) an atomization controller for adjusting atomization parameters to maximize the rate of gas well liquids removed.

13. The system of claim 12, further comprising a flow meter for determining the velocity of produced gas.

14. The system of claim 13, wherein the average droplet size is selected with reference to the velocity of produced gas.

15. The system of claim 12, wherein the apparatus for atomizing gas well liquids within a wellbore comprises at least one piezoelectric device, pneumatic atomizer, atomizing nozzle, surface acoustic wave transducer, and combinations thereof.

16. The system of claim 15, wherein the at least one piezoelectric device includes at least one piezoelectric atomizer, piezoelectric nebulizer or piezoelectric actuator.

17. The system of claim 16, wherein each piezoelectric atomizer produces a volume weighted average droplet size of about 1 to about 90 μm.

18. The system of claim 17, wherein each piezoelectric atomizer produces a volume weighted average droplet size of about 1 to about 10 μm.

19. The system of claim 17, wherein each piezoelectric atomizer atomizes liquids at a rate of about 0.5 to about 1.5 l/hr.

20. The system of claim 19, wherein the piezoelectric device includes at least eight piezoelectric atomizers and atomizes liquids at a rate of about 4.0 to about 12.0 l/hr.

21. The system of claim 20, wherein the apparatus for atomizing gas well liquids within a wellbore further comprises a housing, the housing having a first end and a second end, the first end having a liquid inlet and structured and arranged to receive the piezoelectric device, and the second end having an outlet for dispersing the atomized gas well liquids within a gaseous production stream.

22. The system of claim 12, wherein the apparatus for atomizing gas well liquids within a wellbore is deployed, powered, and retrieved with wire line.

23. A kit of parts for removing liquids from a gas well, the kit of parts comprising:
(a) an apparatus for atomizing gas well liquids within a wellbore to produce a volume weighted average droplet size of less than or equal to about 400 μm and entraining the atomized gas well liquids in a gaseous production stream for removal from the gas well; and
(b) an atomization controller for adjusting atomization parameters to maximize the rate of gas well liquids removed.

24. The kit of parts of claim 23, further comprising a flow meter for determining the velocity of produced gas.

25. The kit of parts of claim 23, wherein the apparatus for atomizing gas well liquids within a wellbore comprises at least one piezoelectric device, pneumatic atomizer, atomizing nozzle, surface acoustic wave transducer, and combinations thereof.

26. The kit of parts of claim 25, wherein the at least one piezoelectric device includes at least one piezoelectric atomizer, piezoelectric nebulizer or piezoelectric actuator.

27. The kit of parts of claim 25, wherein each piezoelectric atomizer atomizes liquids at a rate of about 0.5 to about 1.5 l/hr.

28. The kit of parts of claim 25, wherein the piezoelectric device includes at least eight piezoelectric atomizers and atomizes liquids at a rate of about 4.0 to about 12.0 l/hr.

29. The kit of parts of claim 22, wherein the apparatus for atomizing gas well liquids within a wellbore further comprises a housing, the housing has a first end and a second end, the first end having a liquid inlet and structured and arranged to receive the piezoelectric device, and the second end having an outlet for dispersing the atomized gas well liquids within a gaseous production stream.

30. The kit of parts of claim 22, wherein the apparatus for atomizing gas well liquids within a wellbore further comprises a housing, the housing has a first end and a second end, the first end having a liquid inlet and structured and arranged to receive the piezoelectric device, and the second end having an outlet for dispersing the atomized gas well liquids within a gaseous production stream.

31. The kit of parts of claim 23, wherein the apparatus for atomizing gas well liquids within a wellbore includes a plurality of atomizing devices arranged in a series of sequential stages.

32. An apparatus for removing liquids from a gas well, the apparatus comprising:
a) a piezoelectric device for atomizing gas well liquids and entraining the atomized liquids in a gaseous production stream for removal from the gas well; and
b) an apparatus for maintaining the position of the piezoelectric device adjacent the liquid/gas interface of the gas well.

33. The apparatus of claim 32, wherein the piezoelectric device includes at least one piezoelectric atomizer, piezoelectric nebulizer or piezoelectric actuator.

34. The apparatus of claim 33, wherein the piezoelectric device includes a plurality of piezoelectric atomizers.

35. The apparatus of claim 34, wherein the piezoelectric device further comprises a circular base, the plurality of piezoelectric atomizers positioned about a radius thereof.

36. The apparatus of claim 35, wherein each piezoelectric atomizer produces a volume weighted average droplet size of less than about 400 μm.

37. The apparatus of claim 35, wherein each piezoelectric atomizer produces a volume weighted average droplet size of about 1 to about 90 μm.

38. The apparatus of claim 37, wherein each piezoelectric atomizer produces a volume weighted average droplet size of about 1 to about 50 μm.

39. The apparatus of claim 38, wherein each piezoelectric atomizer produces a volume weighted average droplet size of about 1 to about 10 μm.

40. The apparatus of claim 36, wherein each piezoelectric atomizer atomizes liquids at a rate of about 0.5 to about 1.5 l/hr.

41. The apparatus of claim 40, wherein the piezoelectric device includes at least eight piezoelectric atomizers and atomizes about 4.0 to about 12.0 l/hr.

42. The apparatus of claim 33, wherein the apparatus for maintaining the position of the piezoelectric device adjacent the liquid/gas interface of the gas well comprises a float.

43. The apparatus of claim 1, further comprising a housing, the housing having a first end and a second end, the first end having a liquid inlet and structured and arranged to receive the piezoelectric device, and the second end having an outlet for dispersing the atomized gas well liquids within a gaseous production stream.

44. A method for removing liquids from a gas well, the method comprising the steps of:
a) positioning a piezoelectric device for atomizing gas well liquids adjacent the liquid/gas interface of the gas well;
b) powering the piezoelectric device and generating droplets;
c) entraining the droplets in a gaseous production stream;
d) producing the gaseous production stream having entrained droplets; and
e) maintaining the position of the piezoelectric device adjacent the liquid/gas interface of the gas well.

45. The method of claim 44, wherein the piezoelectric device includes at least one piezoelectric atomizer, piezoelectric nebulizer or piezoelectric actuator.

46. The method of claim 45, wherein the piezoelectric device includes a plurality of piezoelectric atomizers.

47. The method of claim 46, wherein the piezoelectric device further comprises a circular base, the plurality of piezoelectric atomizers positioned about a radius thereof.

48. The method of claim 47, wherein each piezoelectric atomizer produces a volume weighted average droplet size of less than about 400 μm.

49. The method of claim 47, wherein each piezoelectric atomizer produces a volume weighted average droplet size of about 1 to about 90 μm.

50. The method of claim 48, wherein each piezoelectric atomizer atomizes liquids at a rate of about 0.5 to about 1.5 l/hr.

51. The method of claim 50, wherein the step of maintaining the position of the piezoelectric device adjacent the liquid/gas interface of the gas well includes the use of a float.

52. The method of claim 44, further comprising arranging a plurality of the atomizing devices in a series of sequential depth stages within the wellbore to maximize liquid throughput and effectiveness.

53. A kit of parts for removing liquids from a gas well, the kit of parts comprising:
a) a piezoelectric device for atomizing gas well liquids and entraining the atomized liquids in a gaseous production stream for removal from the gas well; and
b) an apparatus for maintaining the position of the piezoelectric device adjacent the liquid/gas interface of the gas well,
wherein the piezoelectric device is enclosed within a housing, the housing has a first end and a second end, the first end having a liquid inlet and structured and arranged to receive the piezoelectric device, and the second end having an outlet for dispersing the atomized gas well liquids within a gaseous production stream.

54. The kit of parts of claim 53, wherein the piezoelectric device includes at least one piezoelectric atomizer, piezoelectric nebulizer or piezoelectric actuator.

55. The kit of parts of claim 53, wherein the piezoelectric device includes a plurality of piezoelectric atomizers.

56. The kit of parts of claim 53, wherein the apparatus for maintaining the position of the piezoelectric device adjacent the liquid/gas interface of the gas well comprises a float, the float affixed to an outer surface of the housing.

57. The kit of parts of claim 53, further comprising a wire line for deploying, powering, and retrieving the piezoelectric device.

58. The kit of parts of claim 53, wherein the apparatus for atomizing gas well liquids within a wellbore includes at least one of (i) a plurality of atomizing devices arranged in a series of sequential stages to maximize liquid throughput and effectiveness, and (ii) a chemical reaction-based effervescent fluid atomizer.
